(19) United States
(12) Patent Application Publication
(10) Pub. No.: US 2019/0363525 A1
(43) Pub. Date: Nov. 28, 2019

(54) Stripzall Reciprocating blade

(71) Applicant: Hunter Franssen, Coeur D'Alene, ID (US)

(72) Inventor: Hunter Franssen, Coeur D'Alene, ID (US)

(21) Appl. No.: 15/784,119

(22) Filed: Oct. 14, 2017

(51) Int. Cl. H02G 1/12

(52) U.S. Cl. CPC H02G 1/1202

(57) ABSTRACT

A mountable blade of the reciprocating type for cutting and stripping insulation from insulated electrical conductors is provided which is capable of stripping or cutting a section of the outer jacketing, coating, or insulation of the electrical wire, copper or aluminum

### BACKGROUND OF THE INVENTION

### 1. Field of the Invention

This invention pertains to cutting tool, and more particularly to a reciprocating blade for cutting and stripping insulation from insulated electrical conductors.

### 2. Description of the Prior Art

Many terminations of both electrical and optical cables require that the cable be stripped with a section of cable jacket removed from the inner cable core. In all cases, the object of the stripping operation is to remove a section of jacket precisely and cleanly without damaging the inner core in any way. This objective is frequently not met because in order to remove the section of cable jacket during stripping, the cable must be tightly gripped to deform and mark the cable jacket adjacent to the stripped section. Additionally, the pulling of the jacket to remove the stripped section may place tensional loads on both the jacket and the cable core to result in damage to these cable components. Another problem lies with the blades used to strip cable which may nick the cable core, resulting in poor transmission of optical energy in the case of glass or plastic fiber optic cables or in weakened strands in the case of copper electrical conductors.

Industry utilizes two basic types of cutting blades for high production stripping of insulation from insulated electrical conductors, the die type and the V type. In the die type design, a pair of knife blades forms two halves of a counter bored hole and a smaller through hole. The two blades are closed over the insulation of a specifically sized insulated conductor at the desired location thereon. The die type design possesses the advantages of closely conforming to the configuration of the conductor around the full periphery thereof and of having a depth of cut controlled by the contacting of leading edges to prevent nicking and scoring the conductor. Nicking a conductor is undesirable because nicks decrease the electrical current carrying capacity, and they produce stress concentrations which decrease the tensile strength of the conductor. However, die type blades suffer from three disadvantages. The first is that a pair of die blades is designed to be used with only one size of insulated conductor. Secondly, the squeezing of the insulation between the conductor and the blades may prevent the blades from fully closing onto the conductor. The insulation is then not completely cut through to the conductor. Rather, some of the insulation is squeezed in the area between the leading edges and the conductor. As a result, the uncut insulation must be torn from the parent insulation. The third disadvantage is that die type blades have only a low tolerance for accommodating off-center insulated conductors transported between the open blades. In many applications, special wire guides in the form of mechanical fingers are required to ensure the insulated conductor is on the center line of the closed blades.

For a pair of conventional V type blades, each blade is manufactured with a sharp edged cutting radius at the bottom of the V for slicing through the insulation. The cutting radius is ideally equal to one-half of the outer diameter of the conductor to be stripped, but a single pair of V type blades can cut and strip several sizes of insulated conductor. Another advantage of the V type blade design is that the sharp knife edges slice through the insulation to the conductor rather than squeezing the insulation. On the other hand, conventional V type designs lack positive stroke control; therefore the conductor is prone to be nicked and scored when stripped.

Thus, it is a general object of this invention to provide a new and improved powered reciprocating blade.

It is a primary object of this invention to provide a new and improved powered reciprocating blade which has fewer parts, may be adapted to a greater number of situations, and is provided with structure which promotes the longevity of blade life.

A more detailed object is to provide a new and improved powered blade of the reciprocating type wherein a blade is provided with an arcuate structure.

Another object of this invention is to provide a new and improved powered blade of the reciprocating type wherein the rotary movement of the motor is translated into reciprocating movement of the blade by means of one intermediate rotating member which is provided with means for driving an interconnecting link between the rotating member and the blade holder.

Another object of this invention is to provide a new and improved powered blade of the reciprocating type wherein the blade is provided with a novel and unique blade holder which permits the blade to be connected to the blade so that the cutting edge thereof extends lengthwise of the blade or generally transverse thereto.

Yet another more detailed object of this invention is to provide an improved stripping blade which minimizes damage to a cable, its jacket and core during stripping operations. It is a further object to provide a stripping blade for cable that facilitates a precise, clean, and non-damaging removal of a section of cable jacket from a cable core. It is a final object to provide a stripping blade capable of stripping wires and cables of different sizes.

### SUMMARY OF THE INVENTION

In accordance with the present invention, a mountable blade of the reciprocating type for cutting and stripping insulation from insulated electrical conductors is provided which is capable of stripping or cutting a section of the outer jacketing, coating, or insulation of the electrical wire, copper or aluminum. Owing to the shape of the blade there is no limit to the size or gauge of wire it can strip which can range from 14 AWG to 1000 AWG (American Wire Gauge). This is accomplished by the use of a powered tool of the reciprocating type which can be corded or cordless.

In accordance with one embodiment of the present disclosure, a blade for cutting and stripping insulation from insulated wires/electrical conductors, as an accessory for a power tool, includes a mounting portion configured to mate with a reciprocating drive member of a power tool. A support arm portion extends from the mounting portion in a first direction. The support arm portion includes an inner edge that faces in a second direction transverse to the first direction. A blade portion extends from the support arm generally in the second direction. The blade portion includes a trailing edge arranged facing generally toward the mounting portion and a leading edge arranged facing generally away from the mounting portion. The trailing edge and the leading edge portion meet to define a rounded tip portion.

Other objects and advantages of the invention including without limitation construction, demolition, carpet cutting, and wood working will become apparent to those skilled in the art from the disclosure.

### BRIEF DESCRIPTION OF THE DRAWINGS

FIG. 1 is a top elevational view of the reciprocating blade;

FIG. 2 is a perspective view of the top of a power tool including with the reciprocating blade according to one embodiment of the present disclosure;

FIG. 3 is a top view of oscillating blade;

FIG. 4 is a perspective view of the oscillating blade according to one embodiment the present disclosure

### DETAILED DESCRIPTION OF THE INVENTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one of ordinary skill in the art to which this invention pertains.

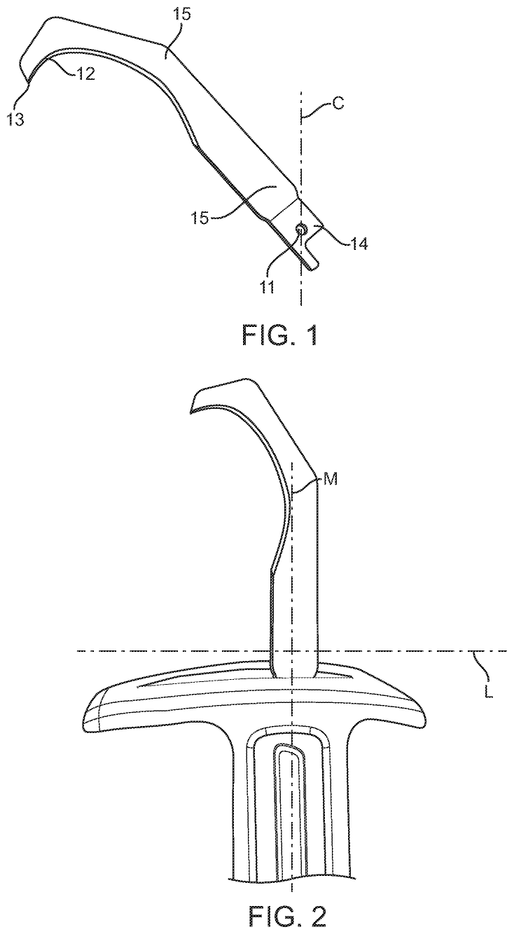

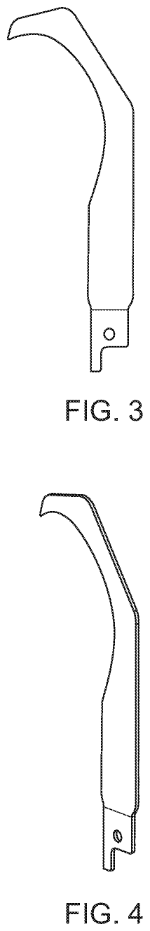

Referring to FIG. 1, a blade for stripping and cutting generally cylindrical bodies is illustrated which includes the present invention. The cutting blade is particularly useful for cutting and stripping insulation from insulated electrical conductors, but it will be understood that the invention is not limited to electrical applications.

Referring to FIGS. 1 and 2, the present disclosure is directed to mounted blade for a reciprocating power tool. Mounted blade facilitates using the reciprocating power tool in cutting and stripping electrical wires and conductors. Mounted blade includes a mounting portion, a support arm portion 15, and a blade portion 12. The mounting portion secures the blade to the reciprocating tool. The blade that is arcuate shaped at its upper end will be stamped out of tool steel and sharpened. The top of the blade which is the cutting blade portion 12 has almost a semicircular shape at the cutting end like a large teeth of a Rip blade and the other upper end has the two top sides of an irregular hexagon. The lower end which is the arm portion has a rectangular body 14. At this lower end on the mounting portion is a small hole which is the mounting portion which will enable it to be run by many different manufacturers of reciprocating tools.

Referring now to FIG. 2, the reciprocating tool defines a longitudinal axis L. A reciprocating drive member (not shown) extends generally perpendicularly with respect to the longitudinal axis L. The motor is configured to move in a forward and backward motion about an axis M at high frequencies, allowing the blade to cleanly and evenly cut through the insulation on the exterior of the wire. It cuts through a small section of the insulation so that the rest of the insulation can easily be pulled off revealing the inner copper or aluminum core.

The drive member supports an accessory tool holder exterior to the housing. The tool holder is configured to secure various accessory tools to the drive member, such as mounted blade.

Mounted blade comprises a planar body formed of a hard metal material, such as carbon steel. Mounted blade may be formed by stamping sheet metal with one or more dies that define the perimeter shape and openings of the tool. As depicted, the body is shaped to form a mounting portion 11, a support arm portion 15, and a cutting blade portion 12.

The mounting portion has a central opening. The mounting portion defines a central axis C that is centered in the slot and central opening. The central axis C of the mounting portion defines the default mounting orientation of the blade and serves as a guide for mounting the blade to the tool holder of the reciprocating tool. In the default mounting orientation, the mounting portion is secured to the tool holder with the central axis C aligned with the longitudinal axis L of the reciprocating tool. The mounting portion, however, can be secured to the tool holder with the central axis C oriented in a plurality of different directions that are transverse to the longitudinal axis L. The mounting portion is secured to the tool holder with the body of the blade arranged parallel to the axis M (FIG. 2) of the drive member.

The support arm offsets the blade from the mounting portion so the blade, and particularly the semi circular cutting edge 12, can be arranged substantially perpendicular to the directions of reciprocating movement of the drive member. The semi circular edge serves as a guide surface and facilitate the cutting or stripping of the wires.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected

Thus, it is apparent that there has been provided, in accordance with the invention, a mountable blade for stripping insulated electrical conductors which fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. A blade for cutting and stripping insulation from insulated electrical conductors comprising a
a mounting portion configured to mate with a reciprocating drive member of a power tool
wherein a support arm portion extends from the mounting portion in a first direction and includes an inner edge that faces in a second direction transverse to the first direction
a blade portion extends from the support arm generally in the second direction
wherein the blade portion includes a trailing edge arranged facing generally toward the mounting portion and a leading edge arranged facing generally away from the mounting portion. The trailing edge and the leading edge portion meet to define a rounded tip portion.

2. The mountable blade of claim 1, wherein the trailing edge includes a circular cutting edge.
